(19) United States
(12) Patent Application Publication
(10) Pub. No.: US 2007/0279906 A1
(43) Pub. Date: Dec. 6, 2007

(54) Mounting arrangement for LED lamps

(75) Inventors: Xi Yuan He, Panyu (CN); Rui Ma, Panyu (CN); Giovanni Scilla, Fontane Di Villorba (TV) (IT)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCHE GLUHLAMPEN MBH, MUNCHEN (DE)

(21) Appl. No.: 11/806,135

(22) Filed: May 30, 2007

(30) Foreign Application Priority Data
May 31, 2006 (EP) 06425372

(51) Int. Cl. F21V 33/00

(52) U.S. Cl. 362/253

(57) ABSTRACT

A LED lighting arrangement includes a support body having mounted thereon one or more LED lighting sources and a driver or feeding the LED lighting sources. The support body includes a high-voltage section carrying the driver and a low-voltage section carrying, mounted on a heat sink, the light sources. An insulation barrier is provided between the high voltage section and the low-voltage section of the board with a twisted pair forming a wiring that traverses the insulation barrier to connect the driver and the LED lighting sources.

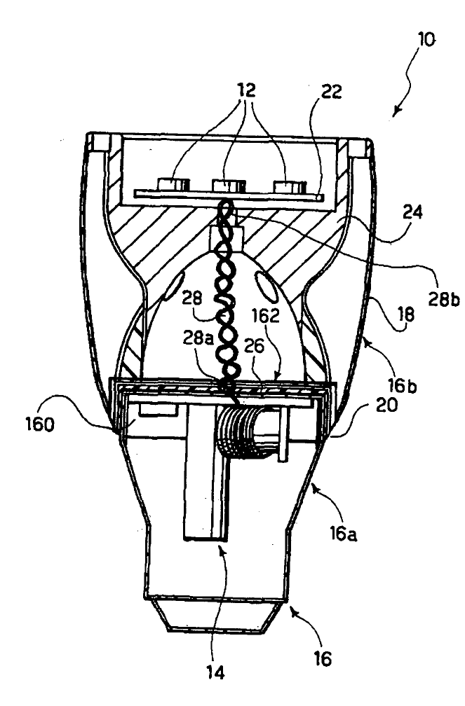

### FIELD OF THE INVENTION

The invention relates to LED lamps and, more specifically, to mounting arrangements for such lamps.

### DESCRIPTION OF THE RELATED ART

Light emitting diodes (or LEDs) are meeting with an increasing success in their use as lighting sources, i.e. as lamps. This applies particularly to so-called high-flux (HF) LEDs. A significant advantage of LED lamps lies i.a. in the possibility of grouping together several LED sources having different emission wavelengths characteristics with the ensuing possibility of selectively varying the chromatic characteristics of the resulting lighting radiation thus produced.

Proper heat sinking of such LED-based lighting sources is a key requirement to preserve the operating life time of the LEDs for a long time. Direct coupling of high-flux LEDs onto a metal heat sink and accessible (that is, unshielded) heat sink operation in open air for thermal dissipation by convection are strongly preferred. Accessible heat sink operation means that the heat sink and the LED side, that is the secondary side of the transformer feeding the LED source(s), are accessible so that they can be safely touched by a user during operation. The heat sink that the LED side of the LED lamp must thus properly insulated by satisfying the requirements in terms of creepage/clearance distances, insulation resistance and dielectric strength dictated by safety standards such as SELV-rated insulation, SELV being an acronym for Safety Extra Low Voltage.

The need is therefore felt for a properly insulated (e.g. SELV-rated) systems for LED lamps, this being particularly the case for self-ballasted high-flux LED lamps supplied from an AC line, such as the common household mains voltage.

### OBJECT AND THE SUMMARY OF THE INVENTION

The object of the invention is to provide a fully satisfactory response to that need.

According to the invention, that object is achieved by means of an arrangement having the features set forth in the claims that follow. The claims are an integral part of the disclosure of the invention provided herein.

The arrangement described herein is adapted to provide a self-rated insulation system for a self-ballasted high-flux LED lamp supplied from an AC line by providing a number of significant advantages. These include, i.e.:
an easier and more reliable compliance with SELV requirements,
smaller dimensions of the printed circuit board (PCB) onto which the lamp driver is mounted, and
a reduced number of wire connections to the light source from the high-voltage section of the driver circuitry.

### BRIEF DESCRIPTION OF THE ANNEXED REPRESENTATIONS

The invention will now be described, by way of example only, by referring to the enclosed figure of drawing, which represents a general sectional view of a mounting arrangement as described herein.

### DETAILED DESCRIPTION OF A PREFERRED EMBODIMENT OF THE INVENTION

In the annexed figure of drawing, reference 10 designates as a whole a lighting source (i.e. a “lamp”) including at least one light emitting diode (LED), and, preferably, a plurality of LEDs 12 as the generating source of the lighting radiation. Typically, the LEDS 12 are of the high-flux (HF) type and are fed via an electronic driver 14.

The lamp 10 is essentially includes a support body 16 onto which the LED sources 12, the driver 14 and a number of components associated therewith are mounted as better detailed in the following.

These components are at least partly enclosed within a casing 18. In a preferred embodiment as described herein the casing has a shape somewhat reminiscent of the shape of a conventional light bulb with the LED sources 12 at its distal end and the driver 14 at its proximal end, respectively.

As clearly visible in the drawing, the body 16 is partitioned into two sections, namely a high-voltage (HV) section 16a and a low-voltage (SELV) section 16b. The two sections 16a, 16b may be separated by a gap 20 extending along a non-rectilinear path. Typically, one of the two sections 16a, 16b, preferably the section 16a, includes a protruding portion 160 extending into a corresponding recess 162 in the other section 16b to a produce a mating relationship between the two board sections 16a, 16b.

Typically, the LED sources 12 are carried by a board 22 and are directly mounted on a heat conductive metal (e.g. aluminium, light-alloy) heat sink 24. The heat sink 24 has a hollow domed-shaped section 24a opening towards the driver 14 with the interposition of insulating (e.g. plastics) layer forming a barrier or shield 26. The layer 26 is typically in the form of a cap mounted (e.g. by snap-fit engagement) onto the protrusion 160 of the high-voltage section 16a of the body 16 in order to at least partly surround the transformer 14 carried thereby.

Finally, reference 28 indicates a twisted wire pair connecting the secondary winding of the transformer 10 to the LED sources 12. The wiring 28 extends through corresponding holes 28a and 28b provided in the barrier 26 and in the heat sink 24, respectively. Using a twisted pair for the wiring 28 provides an improved radio frequency interference (RFI) behaviour and is also advantageous because only two wire solderjoints, in the place of four, must be soldered to achieve the proper connection.

In a preferred embodiment of the arrangement described herein, the driver 14 includes a fly-back transformer whose secondary winding is comprised of a triple-insulation wire. Preferably, the secondary winding of the transformer is not soldered in correspondence with the transformer bobbin: a so-called “floating” connection is thus preferred in order to minimize (and notionally dispense with) creepage/clearance requirements. Typically, the transformer is an insulation transformer that keeps 6 mm creepage/clearance and 4 kV insulation between the high-voltage and the low-voltage sections of the circuit (in the case of 230 V ac line voltage).

The LED lamp arrangement described herein is thus partitioned into sections:
a high-voltage section, identified by the body section 16a, that includes the driver 14 as well as the associated circuitry (of a known type) for providing input rectification and dc-dc conversion via e.g. a fly-back converter arrangement, and
a low-voltage section, identified by the body section 16b, that includes the LED sources 12 directly coupled (i.e. mounted) to the heat sink 24 as well as the associated circuitry (again of a known type) for providing secondary rectification and the wiring to the light source board 22.

The high-voltage section 16a and the low-voltage section 16b referred to in the foregoing are separated by an insulation barrier. This is essentially provided by the insulation transformer 14 and the plastic barrier 26 mounted thereon.

The barrier 26 is preferably comprised of plastic body essentially in the form of a cap adapted to achieve mechanical connection of the two sections of the arrangement while ensuring (possibly together with the gap 20, if present) the desired degree of separation. The size of the hole 28a through the cap 26 can be kept to a minimum value for the wiring 28 to pass therethrough.

The arrangement described herein achieves an optimal coupling of the light source body section 16b towards the heat sink 24 which is conductive and must be accessible (i.e. freely touchable) during operation. Consequently, this section of the “lamp” plus the heat sink 24 are properly insulated, e.g. SELV-rated. The arrangement disclosed is intended to be supplied directly from the mains voltage whereby the SELV requirements (creepage/clearance distances, insulation resistance, dielectric strength) are very strong. The arrangement described herein meets these requirements without any appreciable negative impact on miniaturization, costs of materials and assembly, reliability in large-scale production.

Of course, without prejudice to the underlying principles of the invention, the details and embodiments may vary, even significantly, with respect to what has been described and shown just by way of example, without departing from the scope of the invention as defined by the annexed claims.

1. A LED lighting arrangement including a support body (16) having mounted thereon at least one LED lighting source (12) and a driver (14) for feeding said at least one LED lighting source (12), wherein:
said support body (16) includes a high-voltage section (16a) carrying said driver (14) and a low-voltage section (16b) carrying said at least one LED light source (12),
an insulation barrier (20, 26) is provided between said high voltage section (16a) and said low-voltage section (16b) of said body (16) with a wiring (28) traversing said insulation barrier to connect said driver (14) and said at least one LED lighting source (12).

2. The arrangement of claim 1, characterised in that it includes an electrically conductive heat sink (24) carried by said low-voltage section (16b) of said body (16) and having said at least one LED lighting source (12) mounted thereon.

3. The arrangement of claim 1, characterised in that said driver (14) includes a fly-back transformer.

4. The arrangement of claim 1, characterised in that said transformer has a secondary winding comprised of triple-insulation wire.

5. The arrangement of claim 1, characterised in that said wiring (28) is in the form of a twisted pair.

6. The arrangement of claim 1, characterised in that said insulation barrier includes a gap (20) separating said high-voltage section (16a) and said low-voltage section (16b) of said body (16).

7. The arrangement of claim 6, characterised in that said gap (20) extends along a non-rectilinear trajectory.

8. The arrangement of claim 1, characterised in that said high-voltage section (16a) and said low-voltage section (16b) of said body (16) are arranged in a mating relationship, with a protrusion (160) of one of said sections (16a) extending into a recess (162) of the other (16b) of said high-voltage section (16a) and said low-voltage section (16b) of said body (16).

9. The arrangement of claim 1, characterised in that said insulation barrier includes an insulating layer (26) arranged in correspondence with said driver (14).

10. The arrangement of claim 9, characterised in that said insulating layer (26) is a plastic layer.

11. The arrangement of claim 9, characterised in that said layer (26) is in the form of an insulating shield at least partly surrounding said driver (14).

12. The arrangement of claim 8, characterised in that said layer (26) is in the form of an insulating shield at least partly surrounding said driver (14); characterised in that said protrusion (160) is a protrusion of said high-voltage section (16a) of said body (16) carrying said driver (14) and said insulating layer (26) is a cap mounted onto said protrusion (160).

13. The arrangement of claim 1, characterised in that said driver (14) includes a transformer configured to provide 6 mm creepage/clearance and 4 kV insulation.

14. The arrangement of claim 1, characterised in that said driver (14) includes a transformer (14) with a floating secondary winding.

15. The arrangement of claim 1, characterised in that it includes a casing (18) at least partly enclosing said at least one light source (12) and said driver (14).

16. The arrangement of claim 15, characterised in that said casing (18) has a bulb-like shape.
